(19) United States
(12) Patent Application Publication
(10) Pub. No.: US 2015/0070902 A1
(43) Pub. Date: Mar. 12, 2015

(54) SYSTEM TO DISPERSE LUMINANCE

(71) Applicant: Scott S. YU, Sonoma, CA (US)

(72) Inventor: Scott S. YU, Sonoma, CA (US)

(73) Assignee: VODE LIGHTING, INC., Sonoma, CA (US)

(21) Appl. No.: 14/250,351

(22) Filed: Apr. 10, 2014

Related U.S. Application Data
(60) Provisional application No. 61/813,289, filed on Apr. 18, 2013.

(51) Int. Cl. G02B 5/02; F21V 3/04

(52) U.S. Cl. CPC G02B 5/0263; F21V 3/049; F21Y 2101/02
USPC 362/311.02; 362/311.01

(57) ABSTRACT

A device with a housing with a compartment formed with a first channel abutting one side of said compartment and a second channel, disposed opposite said first channel and abutting said compartment. A first light control is disposed in the first channel and has a portion extending from the first channel over the compartment and a second light control with a portion extending from said second channel over said compartment. A light source is disposed in the compartment and shines light through said first and second light control. The light source may be either a light emitting diode or a fluorescent lamp. The second light control may include a pattern disposed on said second light control which operates to disperse the light.

### PRIORITY

This application claims the benefit of co-pending provisional patent application 61/813,289 filed Apr. 18, 2013 entitled “A System To Disperse Luminance” by the same inventor which is incorporated by reference as if fully set forth herein.

### BACKGROUND

The present invention relates generally to a luminaire and with more particularly to a modular lighting system, comprising a plurality of lighting system components, which can be designed in a variety of different ways. With even more particularity, the invention appertains to a system to distribute light.

Lighting fixtures are one of the basic lighting devices used in homes, offices and a variety of industrial settings. A typical lighting fixture may be mounted on a wall, at a position above a desk, in a corridor, a door entrance, or a garage door such that the lighting fixture can illuminate the area. There are many factors that control the market for luminaires and lighting systems. A few important factors are the ability to create a well-lit hospitable environment, cost efficiency such as operating cost and other associated costs, code compliance, and more particularly the distribution of light and shadows. Traditional luminaires create shadows, specifically hard shadows. Hard shadows are crisply defined and have sharp edges, which can produce a harsh or inhospitable environment. Theses shadows have an umbra, a completely dark shadow cast by an object. Hard shadows lack a penumbra, which is a partial shadow between the complete shadow and complete luminance, where part of the light source is visible. Hard shadows have a sharp transition between complete luminance and umbra, which creates distinct lines. This issue is magnified when luminance is needed for highlighting an article or specific area, such as a display on a table. In this instance, the hard shadows may cast lines onto the article thus masking features, changing the appearance of the article and altering the intended viewed composition. Additionally lighting designers have the task of positioning luminaires to distribute the light to a specific location. To make the environment's luminance more comfortable and make articles in the surrounding area look more natural, a reduction of bold shadows and control of luminance placement is needed.

### SUMMARY

Disclosed herein is a device comprising: a housing with a compartment formed with a first channel abutting one side of said compartment and a second channel, disposed opposite said first channel and abutting said compartment. A first light control is disposed in the first channel and has a portion extending from the first channel over the compartment and a second light control with a portion extending from said second channel over said compartment. A light source is disposed in the compartment and shines light through said first and second light control. The light source may be either a light emitting diode or a fluorescent lamp. The second light control may include a pattern disposed on said second light control which operates to disperse the light.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 depicts certain aspects in an exploded view of one embodiment of a system to distribute luminance.

FIG. 2A and FIG. 2B show two alternate embodiments of a system to distribute luminance without secondary light controls.

FIG. 3 illustrates one embodiment of a system to distribute luminance according to aspects of the current disclosure.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

Lexicography

The term light source generally includes conventional light sources such as incandescent bulbs, fluorescent lamps, light emitting diodes (LEDs), halogen lamps and the like.

The term “luminaire” generally refers to a lighting unit consisting of a light source such as a lamp or light emitting diode (LED) together with the parts designed to distribute the light, to position and protect the light sources, and to connect the light sources to a power supply. In some instances a luminaire may not include a light source, but may be operable to

The term “luminance” generally refers to the brightness of a light source or an object that has been illuminated by a source.

The term “translucent” generally refers to permitting light to pass through an object while diffusing the light.

Detailed Description

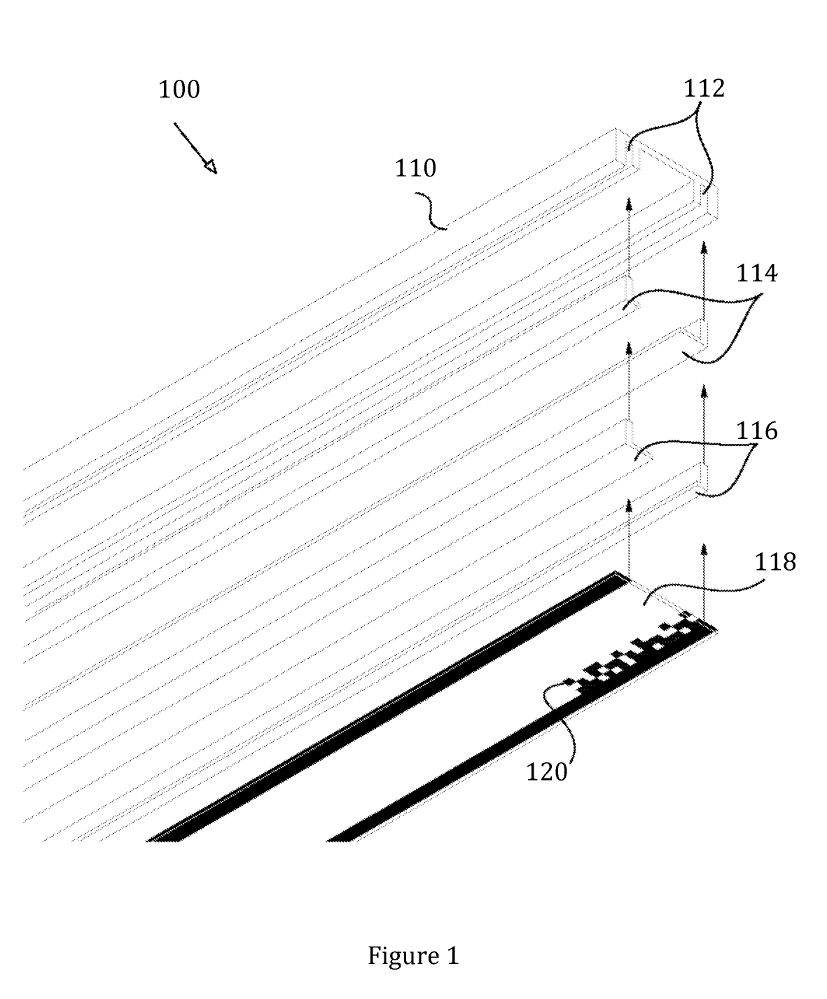

FIG. 1 depicts certain aspects in an exploded view of one embodiment of a system to distribute luminance 100. The system to distribute luminance 100 has a housing 110. The housing 110 is formed having a pair of channels 112 running along the walls of the housing 110. In between the channels 112 is a compartment for housing lighting components, such as a lamp or LED (not shown). The inventor contemplates using extruded plastic or metal to form the housing 110. However, one skilled in the art would recognize the use of other suitable materials that can provide the material strength required for supporting a luminaire. This embodiment of a system to distribute luminance 100 allows for use of a single extruded housing 110, in place of multiple extrusions.

Primary Light Control

The housing 110 is coupled to a primary light control 114. The primary light control 114 is formed having a complimentary shape to that of the channels 112 to effectuate coupling of the primary lighting control 114 to the housing 110. Adjoining the complimentary shape of the primary lighting control 114 is an overhang. The overhang, when coupled to the housing 110, covers a portion of the housing's 110 compartment. As such, the primary lighting control 114 acts to shield light emitted from a light source. Depending on the type of shielding necessary, the primary lighting control 114 can be modified. One possible embodiment of a modification is shown as 116. The primary lighting control 116 couples to the housing 110 via the channels 112, in the same manner that the primary lighting control 114 would be coupled.

Certain embodiments include a light source (not shown) placed on the housing 110 such that the light source is placed between the channels. The light source may be one of more LEDs mounted on a circuit board or a lamp affixed to the housing 110. The primary light control is shaped to have part of the light control extending over the space where the light source is positioned. In some embodiments the light control may extend all the way over a light source. As shown in FIG. 1 the lighting controls 114 and 116 may be asymmetrical having the effect that light will be directed out of the compartment at differing angles in response to the shape of the lighting controls 114 and 116. Moreover a lighting designer may employ different shapes to create a desired lighting pattern by modifying the lighting controls 114 and 116. For example and without limitation, lighting controls may be employed to compensate for bright regions (hot spots) emanating from light sources such as LEDs to create the impression of uniform lighting.

Secondary Light Control

A secondary lighting control 118 is also coupled to the housing 110. The secondary lighting control 118 is formed having a size and shape complimentary to that of the coupling side of the housing 110. When coupled to the housing 110, the secondary lighting control 118 provides for bending or diffusing of the light, which affects the pattern of luminance and shadow pattern in the surrounding area. The inventor contemplates using a transparent material but one having skill in the art will appreciate that results of the secondary lighting control 118 may be effectuated using other materials. The secondary lighting control 118 may have a pattern 120, also used to bend or diffuse the light.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

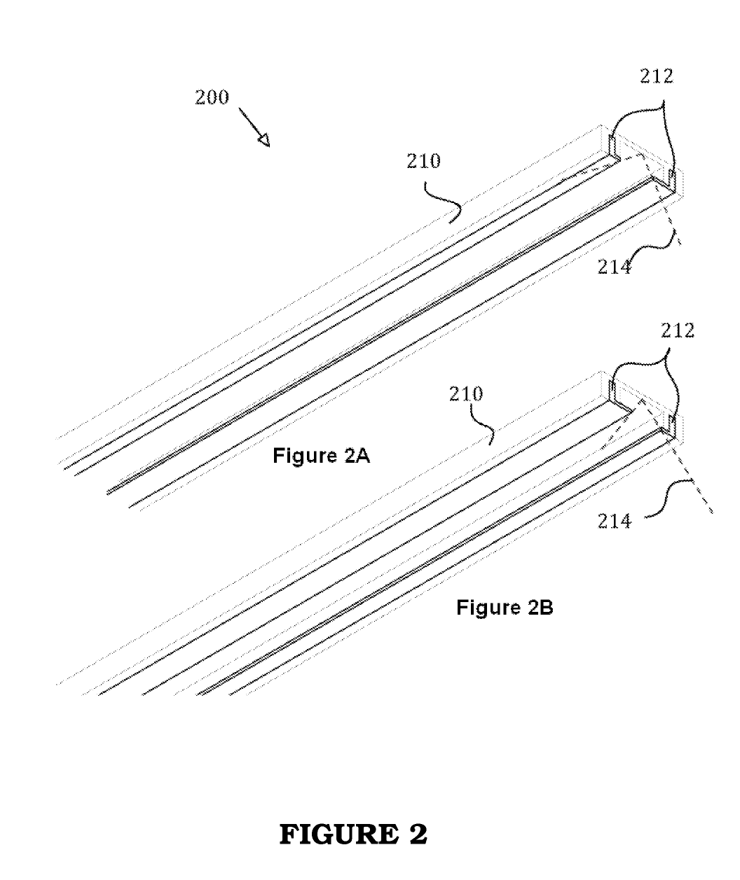

FIG. 2 shows two alternate embodiments of a system to distribute luminance 200 without secondary light controls. The system to distribute luminance 200 is shown in FIG. 2A to have a housing 210 coupled to a primary light control 212. When coupled, the primary light control 212 fits snugly within the channels of the housing 210. In operation, the primary light control 212 blocks part of the housing's 212 open compartment. The placement of primary light control 212 shields light emitted from the lamp (not shown). When the light is shielded, an altered path for a beam of light 214 is created. FIG. 2B shows a different angle and path of a beam of light 214. The cut-off angle is changed when the primary light controls 212 are modified. The primary light controls 212 may be formed using a metal or plastic but one having skill in the art will appreciate that other materials may be used to mask light. In some embodiments the primary light control 212 may employ surfaces with different reflectivity to achieve desired lighting affects.

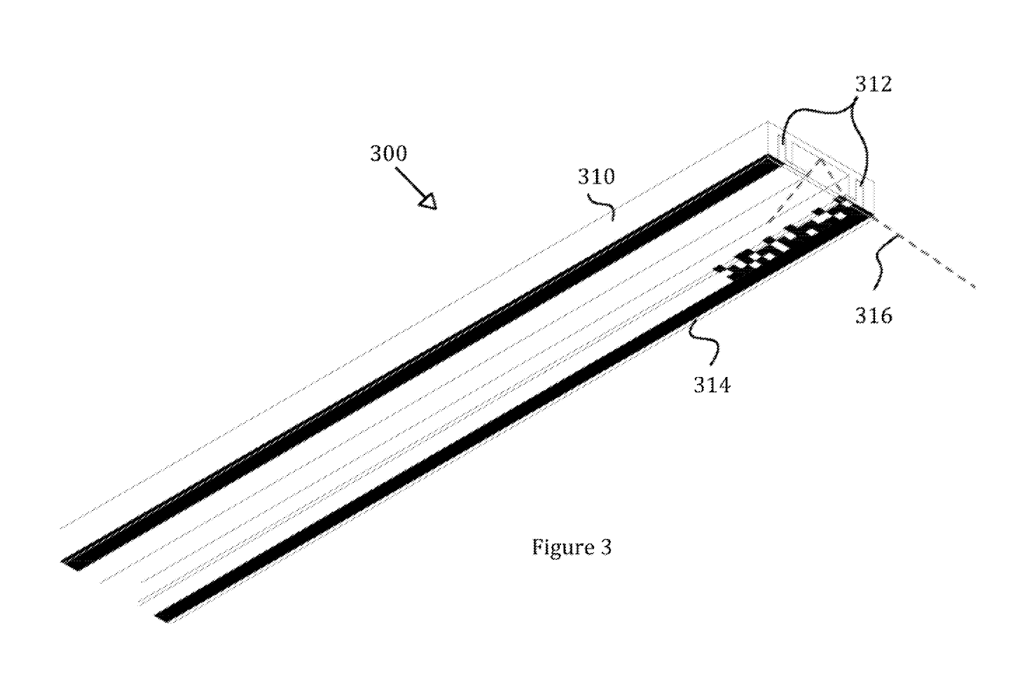

FIG. 3 illustrates one embodiment of a system to distribute luminance 300 according to aspects of the current disclosure. The system to distribute luminance 300 is shown having a housing 310 coupled to a primary light control 312 and additionally coupled to a secondary light control 314. The secondary light control 314, when coupled to the housing 310, is positioned over the primary light control 312 to further control the dispersion of light from the light source (not shown). The altered path for a beam of light 316 resulting from the secondary light control 314 is shown. The secondary light control 314 may have a pattern to help diffuse the light. The inventor contemplates utilizing silkscreen printing or ink jet printing to apply the pattern. However one having skill in the art will appreciate that other methods to apply patterns may be used to mask light.

Depicted in FIG. 3 is one embodiment of a pattern, a soft-shadow pattern. This soft-shadow pattern shown in the figure has a gradient of a highly dense layer of marks to a sparse layer of marks. When placed in front of a lamp, the soft-shadow pattern affects the pattern of luminance and shadow pattern in the surrounding area. As light from the lamp passes through the pattern, the percentage of visible portions of the lamp and the light distributed as it shines through the sparse layer of marks is larger than when passing through the highly dense layer of marks, which allows no light to pass. The soft-shadow pattern diffuses the light from the lamp. The intensity of the light passing through the soft-shadow pattern smoothly varies from no shadow to a complete shadow. This shadow pattern created from the soft-shadow pattern generates regions of umbra and penumbra. As suggested above, the penumbra of the shadow allows for more visible luminance than the umbra of the shadow. This type of light pattern is diffuse and creates no visible hard lines. Thus employing the soft-shadow pattern in a luminaire casts a soft shadow. This type of luminance is optimal to eliminate lines and edges caused from light and shadows and alleviate glare issues. The soft-shadow pattern may be translucent, have different colors, or have a regular or randomized pattern, and is not limited to the features show in the figure.

In operation the embodiments shown and described herein act to direct light from any light sources attached to a housing through the first and second light control to create a desired lighting effect. In some embodiments multiple LED light sources may be employed. Light controls may be constructed using the elements described herein to provide more uniformity to the radiated light pattern or to direct tha light pattern to a certain area or direction. Diffusion patterns may be printed on the second light control to give the appearance of a uniform light source. Moreover, lamps often have hot-spots of intense lighting which may be mitigated using one of more of the light controls described herein.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A device comprising:
a housing, said housing including a compartment formed with a first channel abutting one side of said compartment and a second channel, disposed opposite said first channel and abutting said compartment;
a first light control disposed in the first channel, said first light control including a portion extending from said first channel over said compartment;
a second light control, said second light control including a portion extending from said second channel over said compartment, and
a light source, said light source disposed in said compartment and operable to shine light through said first and second light control.

2. The device of claim 1 wherein the light source is either a light emitting diode or a fluorescent lamp.

3. The device of claim 1 wherein the second light control is either clear or translucent.

4. The device of claim 3 wherein the second light control include a pattern disposed on said second light control.

5. A device comprising:
a housing, said housing disposed to receive at least a first light control;
a first light control coupled to the housing; and
a second light control.

6. The device of claim 6, wherein said second light control is translucent.

7. The device of claim 5, wherein said second light control has a pattern disposed on a surface.

8. The device of claim 7, wherein said pattern is a dot matrix pattern.

9. The device of claim 5, further including a light source, said light source disposed on said housing and operable to splay light.

10. A method including the steps of:
positioning a light source in a compartment, said compartment including at least one channel abutting a side of the compartment;
disposing a first control device in said channel, said control device including a portion extending over said compartment;
disposing a second, translucent control device over said compartment,
whereas light from the light source passes the first light control device and passes through the second light control device.

11. The method of claim 10 wherein the second light control device include a pattern of differing optical transparencies disposed on said surface of the second light control device.

12. The method of claim 10 wherein the light source is either an LED or a fluorescent lamp.
